(19) United States
(12) Patent Application Publication
(10) Pub. No.: US 2020/0106766 A1
(43) Pub. Date: Apr. 2, 2020

(54) METHOD AND SYSTEM FOR SECURITY ASSERTION MARKUP LANGUAGE (SAML) SERVICE PROVIDER-INITIATED SINGLE SIGN-ON

(71) Applicant: Konica Minolta Laboratory U.S.A., Inc., San Mateo, CA (US)

(72) Inventors: Rahul Suraparaju, Fremont, CA (US); Daniel Barber, San Francisco, CA (US)

(73) Assignee: Konica Minolta Laboratory U.S.A., Inc., San Mateo, CA (US)

(21) Appl. No.: 16/146,658

(22) Filed: Sep. 28, 2018

(51) Int. Cl. H04L 29/06; H04L 9/32

(52) U.S. Cl. CPC H04L 63/0815; H04L 67/42; H04L 63/104; H04L 9/3213; H04L 63/0861

(57) ABSTRACT

A method and non-transitory computer readable medium for SAML service provider-initiated single sign-on flow. The method including authenticating a client on an authentication server via a single sign-on method; issuing the client a set of access tokens, the set of access tokens containing a list of claims describing an authenticated user; sending a request for a resource hosted on a SAML-SP server to the authentication server, the request including a domain and uniform resource locator of the authentication server and the set of access tokens; receiving a resource request on the SAML-SP server to access the resource; redirecting the resource request from the SAML-SP server to the authentication server to obtain an authentication of the user using an authentication request protocol message; receiving a SAML SSO request on the authentication server from the SAML-SP server; issuing a SAML SSO response to the SAML-SP server with assertions about the authenticated user.

### FIELD OF THE INVENTION

The present disclosure generally relates to computer networking systems and methods for true seamless SAML (Security Assertion Markup Language) SP-initiated (Service Provider-initiated) SSO (single sign-on) flow via injected and implicit secure authentication of a user, and more particularly, a modified SAML SP-initiated SSO flow, which introduces HTTP (Hypertext Transfer Protocol) redirections that are triggered when the authenticated user initiates SP-initiated SAML flows.

### BACKGROUND OF THE INVENTION

Security Assertion Markup Language (SAML) is an XML standard for exchanging single sign-on (SSO) information between an SAML Federation identity Provider (SAML-IdP) who asserts the user identity and a SAML Federation Service Provider (SAML-SP) who consumes the user identity information. Single sign-on is an authentication process that allows a user to access multiple applications with one set of login credentials. Single sign-on, for example, is a common procedure in enterprises, where a client accesses multiple resources connected to a local area network (LAN).

SAMLv2.0 (Security Assertion Markup Language version 2) supports IDP-initiated and SP-initiated flows. In IdP-initiated SAML SSO flow, the SAML-IdP creates a SAML single sign-on assertion for the user identity, and sends the SAML single sign-on assertion to the SP (Service Provider) in an unsolicited fashion. In SP-Initiated SAML SSO flow, the SP generates a SAML2.0 AuthnRequest (i.e., Authentication Request) that is sent to the SAML-IdP as the first step in the Federation process and the SAML-IdP then responds with a SAML Response, both of these interactions being asynchronous to each other.

IdP-initiated SAML SSO offers such a simplicity to user flow, in a case where the user is already authenticated and visits the SAML-IdP's portal page, the SAML-IdP can construct a SAML2.0 assertion that authenticates the user (La, the user has been authenticated) and he/she can access the otherwise protected resources at the SAML-SP and wherein the SAML-IdP sends the SAMLv2.0 assertion to the SAML-SP, in an unsolicited fashion.

Current SAML 2.0 Federation SP-initiated implementations lack such availability via IdP-initiated SSO flow as a result of the differences in flow semantics.

Choosing IdP-initiated over SP-initiated is not a choice currently under SAMLv2.0. SP-initiated SAML SSO flow can offer significant advantages over IDP-initiated flow, for example, which can include supporting deep links and protection from CSRF (cross-site request forgery) attacks. Deep links being the use of a hyperlink that links to a specific, generally searchable or indexed, piece of web content on a website (e.g. “http://example.com/path/page”), rather than the website's home page (e.g., “http://example.com”). In addition, some of the Service Providers (SPs) don't allow IdP-initiated SAML flows.

During SAML2.0, SP-initiated SSO flow, the user tries to access a protected resource directly on the SP side without the SAML-IdP being aware of such an attempt. In a most typical case where the user is already authenticated (with SAML any authentication service that contains IdP) on a mobile/desktop app, issues that can arise include the Mobile/Desktop client of the mobile device (i.e., being operated by a user) and the Authentication Service (hosting the SAML-IdP) may force the user to re-authenticate. Thus, by requiring the user to re-authenticate, the seam lessness of the SSO process may be lost, that is, otherwise offered by the IdP-initiated SAML SSO flow. In addition, Service Provider's (SP's) need to identify the corresponding SAML-IdP server, if authentication of a federated identity is needed. With SP-initiated login, the SP initially does not know anything about the identity of the user, and the SP can suffer from usability and performance/latency issues, compared to IDP-initiated SAML SSO flow, as user interference is required.

### SUMMARY OF THE INVENTION

In consideration of the above issues, it would be desirable to have a method for desirable to have a system and method for a modified SAML SP-Initiated SSO flow, by introducing HTTP redirections that can be initiated (or triggered) when the authenticated user initiates SP-initiated SAML flows, and which such a modified SAML2.0 SP-initiated flow is to be fully compliant with the SAML2.0 specification.

A method is disclosed for Security Assertion Markup Language (SAML) service provider-initiated (SP-initiated) single sign-on (SSO) flow, the method comprising: authenticating a client on an authentication server via a single sign-on (SSO) method; issuing the client a set of access tokens, the set of access tokens containing a list of claims describing an authenticated user; sending a request for a resource hosted on a SAML-SP server to the authentication server, the request including a domain and uniform resource locator of the authentication server and the set of access tokens; receiving the access request on the authentication server and parsing the set of access tokens from the access request and validating the authenticated user; rendering a page on the authentication server and passing the page with a login cookie bound to the domain of the authentication server to the client, the page containing a JavaScript code that redirects the request to the SAML-SP server from the client; receiving a resource request on the SAML-SP server to access the resource; redirecting the resource request from the SAML-SP server to the authentication server to obtain an authentication of the user using an authentication request protocol message; receiving a SAML SSO request on the authentication server from the SAML-SP server; issuing a SAML SSO response to the SAML-SP server with assertions about the authenticated user; and granting access to the authenticated user to the resource hosted on the SAML-SP server.

A non-transitory computer readable medium storing computer readable program code executed by a processor is disclosed for Security Assertion Markup Language (SAML) service provider-initiated (SP-initiated) single sign-on (SSO) flow, the process comprising: authenticating a client on an authentication server via a single sign-on (SSO) method; issuing the client a set of access tokens, the set of access tokens containing a list of claims describing an authenticated user; sending a request for a resource hosted on a SAML-SP server to the authentication server, the request including a domain and uniform resource locator of the authentication server and the set of access tokens; receiving the access request on the authentication server and parsing the set of access tokens from the access request and validating the authenticated user; rendering a page on the authentication server and passing the page with a login cookie bound to the domain of the authentication server to the client, the page containing a JavaScript code that redirects the request to the SAML-SP server from the client; receiving a resource request on the SAML-SP server to access the resource; redirecting the resource request from the SAML-SP server to the authentication server to obtain an authentication of the user using an authentication request protocol message; receiving a SAML SSO request on the authentication server from the SAML-SP server; issuing a SAML SSO response to the SAML-SP server with assertions about the authenticated user; and granting access to the authenticated user to the resource hosted on the SAML-SP server.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system with a SAML SP-initiated SSO flow via injected and implicit secure authentication of a user in accordance with an exemplary embodiment.

FIG. 2 of a computer or a server in accordance with an exemplary embodiment.

FIG. 3 is an example of SAML SP-initiated SSO flow in accordance with the SAML2 specification.

FIG. 4 is an example of SAML SP-initiated SSO flow in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

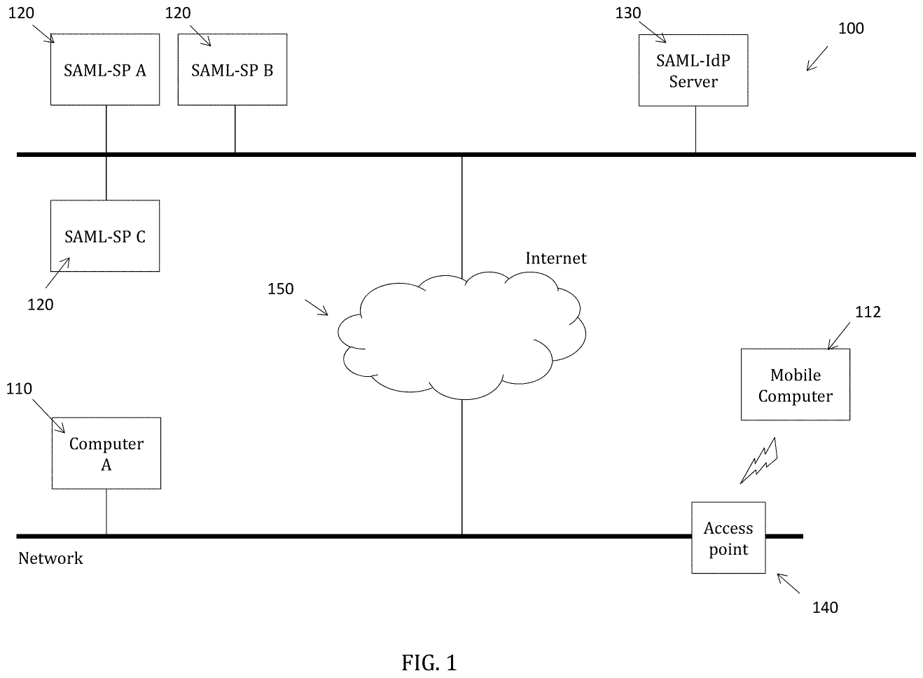

FIG. 1 is an illustration of a system 100, which is capable of a true seamless SAML SP-initiated SSO flow via injected and implicit secure authentication of a user in accordance with an exemplary embodiment. As shown in FIG. 1, the system 100 can include a computer or client device 110, at least one mobile computer 112, a plurality of SAML-SP servers 120, and an authentication server 130. In accordance with an exemplary embodiment, the computer or client device 110, the at least one mobile computer 112, the plurality of SAML-SP servers 120, and the authentication server 130 can be connected via a communication network 150. In addition, for example, an access point 140 can communicate with the communication network 150 to provide wireless or cellular data communication between the mobile computer (for example, a smart phone) 112, and the communication network 150. In accordance with an exemplary embodiment, the access point 140 can be any networking hardware device that allows a Wi-Fi device to connect to a wired network, or a hardware device that can allow a cellular device, for example, a smartphone to connect to the wired network 150.

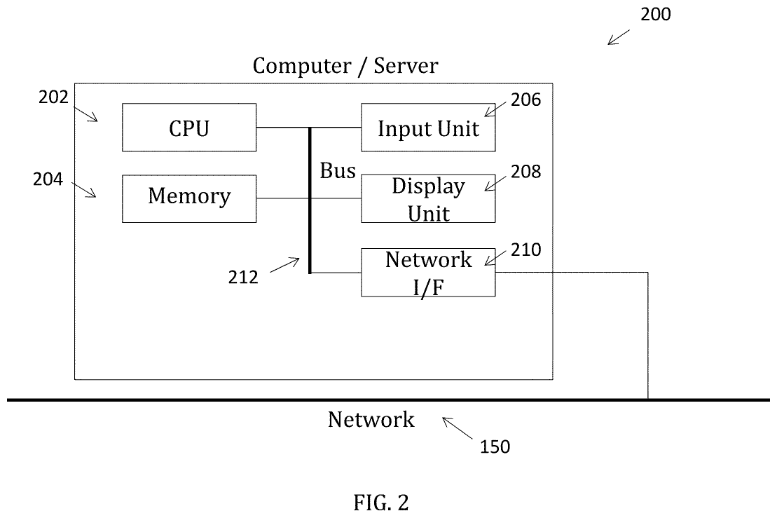

FIG. 2 is an illustration of a computing device 200, which can be a computer 110, a mobile computer 112, a SAML-SP server 120, or an authentication server 130. As shown in FIG. 2, the exemplary computing device 200 can include a processor or central processing unit (CPU) 202, and one or more memories 204 for storing software programs and data (such as files to be printed). The processor or CPU 202 carries out the instructions of a computer program, which operates and/or controls at least a portion of the functionality of the computing device 200. The computing device 200 can also include an input unit 206, a display unit or graphical user interface (GUI) 208, and a network interface (I/F) 210, which is connected to a communication network (or network) 150. A bus 212 can connect the various components 202, 204, 206, 208, 210 within the computing device 200.

In accordance with an exemplary embodiment, the one or more computing devices 200 each can include a display unit or graphical user interface (GUI) 208, which can access, for example, a web browser (not shown) in the memory 204 of the computing device 200. The computing device 200 also includes an operating system (OS), which manages the computer hardware and provides common services for efficient execution of various software programs. In accordance with an exemplary embodiment, the OS of the CPU 202 is a Linux or Windows® based operating system. The software programs can include, for example, application software and printer driver software. For example, the printer driver software controls a multifunction printer or printer (not shown), for example connected with the computing device 200 in which the printer driver software is installed via the communication network 150. In certain embodiments, the printer driver software can produce a print job and/or document based on an image and/or document data.

In accordance with an exemplary embodiment, the plurality of SAML-SP servers 120 are configured to receive and accept authentication assertions in conjunction with a single sign-on (SSO) profile of the Security Assertion Markup Language. In the SAML domain model, a SAML relying party is any system entity that receives and accepts information form another system entity. Of particular interest is a SAML relying party that receives and accepts a SAML assertion issued by a SAML authority. An important type of SAML authority is the SAML identity provider, a system entity that issues authentication assertions in conjunction with an SSO profile of SAML. A relying party that consumes such assertions is called a SAML service provider (or simply service provider if the domain is understood). Thus, a SAML service provider (SAML-SP) is a system entity that receives and accepts an authentication assertion issued by a SAML identity provider (SAML-IdP).

In accordance with an exemplary embodiment, the SAML SP can be any entity that provides organizations with enterprise servers, for example, consulting, legal, real estate, communications, storage, processing. For example, the SAML SP can be a third party or outsource supplier, for example, telecommunication service providers (TSPs), application service providers (ASPs), storages service providers (SSPs) and internet service providers (ISPs).

For example, a TSP is a type of communication service provider that has traditionally provided telephone and similar services, which can include incumbent local exchange carriers, competitive local exchange carriers, and mobile wireless communication companies. An ASP is a business providing computer-based services to customers over a network. For example, an ASP can provide access to a particular software application (such as customer relationship management) using a standard protocol, for example, such as HTTP. A SSP is any company that provides computer storage space and related management services, periodic backup, and archiving.

In accordance with an exemplary embodiment, the SAML-IdP is a system entity that issues authentication assertions in conjunction with a single sign-on (SSO) profile of the Security Assertion Markup Language (SAML). In the SAML domain model, a SAML authority is any system entity that issues SAML assertions. Two important examples of SAML authorities are the authentication authority and the attribute authority.

In accordance with an exemplary embodiment, the computer (or client device) 110 and mobile device 112 can also preferably include an authentication module, which authenticates a user, for example, by fingerprint recognition or authentication, or other authentication protocol, which are currently implemented or will be implemented on mobile devices. For example, a password authentication protocol, which uses credentials, such as username and password can be used.

In accordance with an exemplary embodiment, the communication network or network 150 can be a public telecommunication line and/or a network (for example, LAN or WAN). Examples of the communication network 150 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

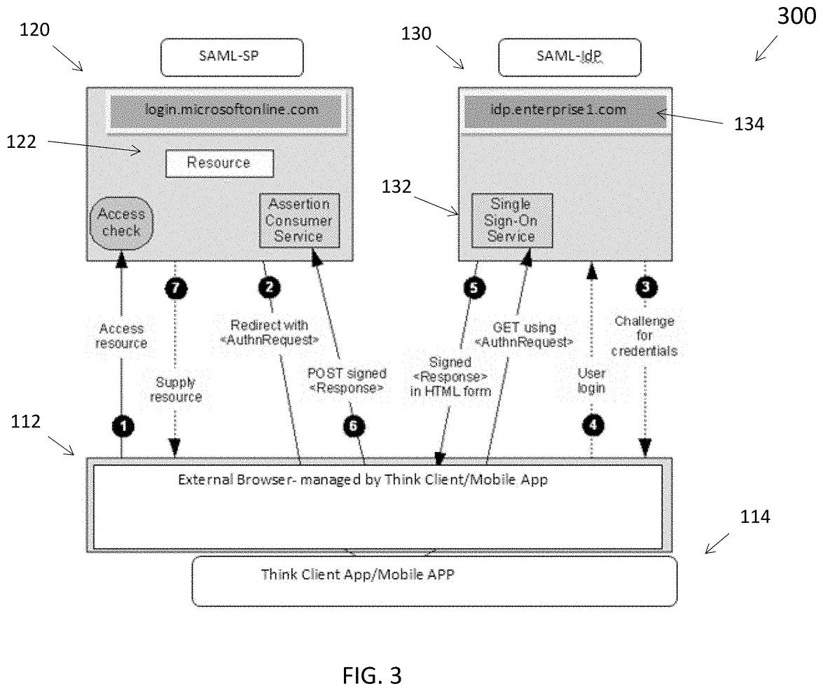

FIG. 3 is an example of SAML SP-initiated SSO flow 300 in accordance with the SAMLv2 specification. As shown in FIG. 3, in step 1, a user with a mobile device (for example, a smart phone) 112 requests a resource, service, or application hosted by the SAML-SP server 120. The request (i.e., access resource) is sent from the mobile device 112 via the communication network 150 to the SAML-SP server 120. In step 2, the SAML-SP server 120 redirects the request back to the authentication server 130, which upon receipt sends a request to the mobile device 112 for a “challenge for credential”, i.e., username and password. In step 4, the user of the mobile device 112 enters the username and password, which is sent to the authentication server 130. In response to receipt of the username and password upon verification, in step 5, the authentication server (i.e., SAML-IdP) 130 sends a signed “Response” in HTML form to the mobile device 112. In step 6, the mobile device 112 forwards a POST signed “Response” to the SAML-SP server 120. POST being a request method supported by HTTP used by the HTTP used by the World Wide Web. By design, the POST request method requests that a web server accepts the data enclosed in the body of the request message. In step 7, the SAML-SP server provides or supplies the requested resource 122 to the mobile device 112.

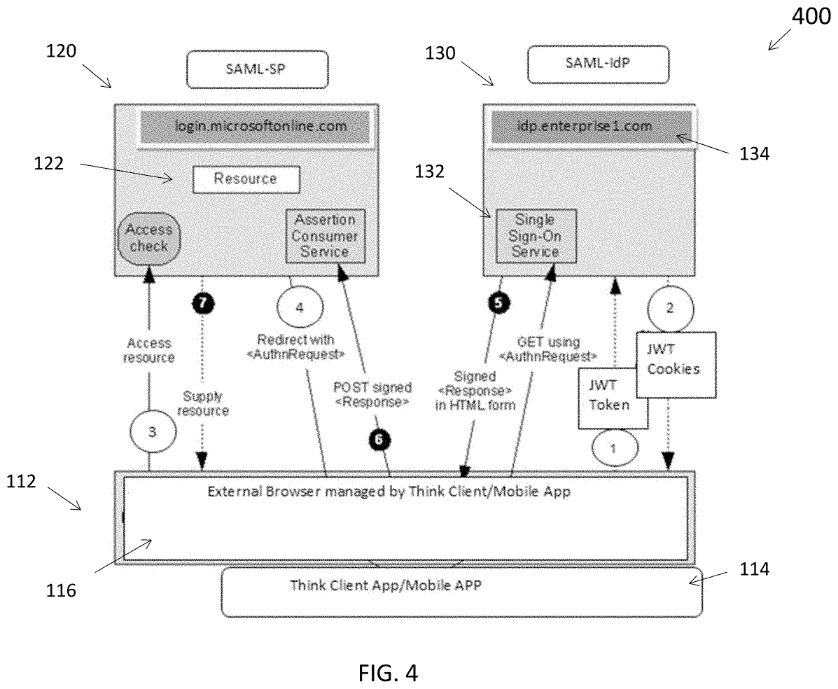

FIG. 4 is an example of SAML SP-initiated SSO flow 400 in accordance with an exemplary embodiment. As shown in FIG. 4, in accordance with an exemplary embodiment, a user of the mobile device 112 logs into a single sign-on (SSO) service 132 hosted on the authentication server 130 using an available authentication single sign-on (SSO) method, for example, a fingerprint, username and password, or pin. For example, the single sign-on (SSO) method can be a biometric, for example, a fingerprint, palm veins, face recognition, DNA, palm print, hand geometry, iris recognition, and/or retina. In accordance with an exemplary embodiment, the authentication server 130 can include a single sign-on (SSO) service 132, which is hosted on the authentication server 130 as shown in FIG. 4.

Upon login to the authentication server 130, for example, with a single sign-on (SSO) service, the client (i.e., mobile device 112) is issued a set of tokens. For example, in accordance with an exemplary embodiment, the set of tokens are based on JSON Web Token (JWT) by the authentication server 130 and the corresponding single sign-on (SSO) service 132 of the authentication server 130. For example, in accordance with an exemplary embodiment, the set of tokens can be HMAC (keyed-hash message authentication code or hash-based message authentication code) SHA256 (secure hash algorithm) encoded. In addition, the keys in the set of tokens contain a list of claims, the list of claims describing the user that has logged in. The list of claims, for example, can include username, permissions, etc. In addition, the JWT tokens can be configured to expire, and can be refreshed.

In accordance with an exemplary embodiment, as shown in FIG. 4, the mobile device 112 preferably has a client application 114, which is configured to provide the user of the mobile device 112 with access to resources or services hosted on a Service Providers (SP), for example, an external web browser 116 managed, for example, by a client or a mobile application 114 (i.e., Think Client/Mobile Application). In accordance with an exemplary embodiment, the user of the mobile device 112 can select a SAML-SP 120. The client application on the mobile device 112 preferably launches a web browser (for example, since most SPs are web based). The web browser 116 being a software application for accessing information on the World Wide Web.

In accordance with an exemplary embodiment, the web browser address is to the domain name/uniform resource locator (domain/url) of the authentication server 130 with the JWT token as part of the address. In step 1, the authentication server 130 receives the request to render the web page of the Service Provider (SAML-SP 120). The authentication server 130 parses the JWT token and validates one or more of a signature, an expiry, etc. (without hitting the database) of the JWT token. In step 2, the authentication server 130 then extracts the claims from the JWT token if the JWT token is valid. In accordance with an exemplary embodiment, the authentication server 130 can use the claims to build a claims principal, which is inserted into a login cookie bound to the domain of the SAML-SP server 120. The login cookie being is a small piece of data sent from the authentication server 130 containing information about the user including, for example, username, permissions, etc.

The authentication server 130 renders a page and passes the login cookie to the web browser of the mobile device 112. In accordance with an exemplary embodiment, in step 3, the page (i.e., request) received from the authentication server 130 contains a JavaScript code that redirects the browser to the SAML-SP 120 (for example, to gmail.com). The SAML-SP 120 receives the request and renders a web page. In accordance with an exemplary embodiment, the user may or may not have to enter a username and/or password upon the SAML-SP 120 receipt of the request from the web browser of the mobile device 112.

In step 4, the SAML-SP server 120 is then redirected to the authentication server 130 (i.e., the Security Assertion Markup Language Identity Provider (SAML-IdP) 134 (for example, idp.enterprise1.com)) to obtain the identity of the user using the single sign-on Security Assertion Markup Language (SSO/SAML). The authentication server 130 (i.e., SAML-IdP 134) receives the SSO/SAML request from the SAML-SP server 120. The authentication server 130 (i.e., SAML-IdP 134) also has the cookie from the authentication server 130 (for example, cookies can be automatically used when the domain is the same). In addition to the available cookie, the claims can also be contained in the cookie.

In accordance with an exemplary embodiment, the SAML-IdP 134 confirms that the cookie is valid and uses the claims to determine the authorization of the user (without hitting the database, i.e., single sign-on server 132). In step 5, the authentication server 130 (i.e., SAML-IdP 134) issues an SSO/SAML response to the SAML-SP 120 and redirects the user back to the SAML-SP address.

In step 6, the SAML-SP 120 receives the SSO/SAML response which contains the assertions (claims) about the user. In step 7, the SAML-SP 120 grants access to the resource (for example, supplies the resources 122 to the authenticate user and mobile device/client 112) and the user can proceed as normal without ever having to login into either the SAML-SP server 120 and/or the authentication server 130.

In accordance with an exemplary embodiment, the service provider, for example, can be microsoftonline.com. The corresponding User ID, SAML subject name, and attributes could be as follows:

| User ID | | |
|---|---|---|
| (primary | SAML Subject Name (email or | Attributes |
| key) | federation string) | (for authorization) |
| 1 | sso_user1@idp.enterprize1.com | Attribute name: ‘role’, |
| | | Attribute value: ‘executive’ |

In accordance with an exemplary embodiment, while handling the extra redirections, the SAML-IdP 134 extracts out required information for the authenticated user, for example, domain name and/or e-mail address to generate the URL to automate, for example, access to the resources at the SAML-SP 120. Thus, the system and methods as disclosed can provide relatively seamless single sign-on (SSO) with all the latency that is otherwise available by user invention providing a lightening true seamless effect to the method and system.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for Security Assertion Markup Language (SAML) service provider-initiated (SP-initiated) single sign-on (SSO) flow, the method comprising:
authenticating a client on an authentication server via a single sign-on (SSO) method;
issuing the client a set of access tokens, the set of access tokens containing a list of claims describing an authenticated user;
sending a request for a resource hosted on a SAML-SP server to the authentication server, the request including a domain and uniform resource locator of the authentication server and the set of access tokens;
receiving the access request on the authentication server and parsing the set of access tokens from the access request and validating the authenticated user;
rendering a page on the authentication server and passing the page with a login cookie bound to the domain of the authentication server to the client, the page containing a JavaScript code that redirects the request to the SAML-SP server from the client;
receiving a resource request on the SAML-SP server to access the resource;
redirecting the resource request from the SAML-SP server to the authentication server to obtain an authentication of the user using an authentication request protocol message;
receiving a SAML SSO request on the authentication server from the SAML-SP server;
issuing a SAML SSO response to the SAML-SP server with assertions about the authenticated user; and
granting access to the authenticated user to the resource hosted on the SAML-SP server.

2. The method according to claim 1, further comprising:
launching a web browser on the client device for sending the request for the resource hosted on the SAML-SP, the request for the resource hosted on the SAML-SP being generated by an application on the client device, and the request having a web browser address, the web browser address having the domain and the uniform resource locator of the authentication server and the a set of access tokens.

3. The method according to claim 1, further comprising:
parsing the set of access tokens and validating the set of access tokens on the authentication server.

4. The method according to claim 1, further comprising:
requesting the authenticated user to enter a username upon the SAML-SP receiving the request redirected from the client.

5. The method according to claim 1, further comprising:
confirming that a cookie received on the authentication server from the SSO SAML request is valid, and using claims in the cookie to determine an authorization level of the authenticated user.

6. The method according to claim 1, wherein the single sign-on (SSO) method is a biometric, the biometric being a fingerprint, palm veins, face recognition, DNA, palm print, hand geometry, iris recognition, and/or retina.

7. The method according to claim 1, wherein the set of tokens is a JSON Web Token (JWT).

8. The method according to claim 7, wherein the JSON Web Token is HMAC SHA256 encoded.

9. The method according to claim 1, wherein the SP is a telecommunication service provider (TSP), an application service provider (ASP), a storage service provider (SSP) and/or an internet service provider (ISP).

10. The method according to claim 1, further comprising:
describing a list of claims for the authenticated user, the list of claims including a username and one or more permissions for accessing content on the SAML-SP server.

11. The method according to claim 1, further comprising:
extracting the list of claims from the set of tokens when the set of tokens are valid.

12. The method according to claim 1, wherein the authentication server is a SAML IdP (Security Assertion Markup Language Identity Provider).

13. The method according to claim 1, wherein once the authenticated user has been granted access to the resource hosted on the SAML-SP server no further login is required.

14. A non-transitory computer readable medium storing computer readable program code executed by a processor for Security Assertion Markup Language (SAML) service provider-initiated (SP-initiated) single sign-on (SSO) flow, the process comprising:
authenticating a client on an authentication server via a single sign-on (SSO) method;
issuing the client a set of access tokens, the set of access tokens containing a list of claims describing an authenticated user;
sending a request for a resource hosted on a SAML-SP server to the authentication server, the request including a domain and uniform resource locator of the authentication server and the set of access tokens;
receiving the access request on the authentication server and parsing the set of access tokens from the access request and validating the authenticated user;
rendering a page on the authentication server and passing the page with a login cookie bound to the domain of the authentication server to the client, the page containing a JavaScript code that redirects the request to the SAML-SP server from the client;
receiving a resource request on the SAML-SP server to access the resource;
redirecting the resource request from the SAML-SP server to the authentication server to obtain an authentication of the user using an authentication request protocol message;
receiving a SAML SSO request on the authentication server from the SAML-SP server;
issuing a SAML SSO response to the SAML-SP server with assertions about the authenticated user; and
granting access to the authenticated user to the resource hosted on the SAML-SP server.

15. The non-transitory computer readable medium according to claim 14, further comprising:
launching a web browser on the client device for sending the request for the resource hosted on the SAML-SP, the request for the resource hosted on the SAML-SP being generated by an application on the client device, and the request having a web browser address, the web browser address having the domain and the uniform resource locator of the authentication server and the a set of access tokens.

16. The non-transitory computer readable medium according to claim 14, further comprising:
parsing the set of access tokens and validating the set of access tokens on the authentication server.

17. The non-transitory computer readable medium according to claim 14, further comprising:
requesting the authenticated user to enter a username upon the SAML-SP receiving the request redirected from the client.

18. The non-transitory computer readable medium according to claim 14, further comprising:
describing a list of claims for the authenticated user, the list of claims including a username and one or more permissions for accessing content on the SAML-SP server.

19. The non-transitory computer readable medium according to claim 14, further comprising:
extracting the list of claims from the set of tokens when the set of tokens are valid.

20. The non-transitory computer readable medium according to claim 14, wherein the authentication server is a SAML IdP (Security Assertion Markup Language Identity Provider), and once the authenticated user has been granted access to the resource hosted on the SAML-SP server no further login is required.
